(19) United States
(12) Patent Application Publication
(10) Pub. No.: US 2011/0029888 A1
(43) Pub. Date: Feb. 3, 2011

(54) CONTROL SERVER AND DISPLAY SCREEN CONTROL SYSTEM OF MULTI-FUNCTIONAL PERIPHERAL

(75) Inventor: Kunihiko Tsujimoto, Osaka (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/846,025

(22) Filed: Jul. 29, 2010

(30) Foreign Application Priority Data
Aug. 3, 2009 (JP) 2009-180674

(51) Int. Cl. G06F 3/00

(52) U.S. Cl. 715/743; 726/8

(57) ABSTRACT

An initial screen is displayed on the display portion of a multi-functional peripheral based on a usage history of a user to secure convenience of the user and the user is prevented from unconsciously using a charged application. An authentication server stores usage history information of function of a multi-functional peripheral capable of executing a function of an external application for each user, stores usage fee information of the external application, extracts a predetermined function out of functions used by a user based on information of the user who logs in the multi-functional peripheral, transmits control information for displaying a screen of the function to the multi-functional peripheral in the case where the predetermined function is free, and transmits the control information for displaying a predetermined alternative screen in stead of the screen of the function to the multi-functional peripheral in the case where the predetermined function is charged.

### CROSS-NOTING PARAGRAPH

This non-provisional application claims priority under 35 U.S.C. §119(a) on Patent Application No. 2009-180674 filed in JAPAN on Aug. 3, 2009, the entire contents of which are hereby incorporated herein by reference.

### FIELD OF THE INVENTION

The present invention relates to a display screen control system of a multi-functional peripheral composed of an application server storing an application, a multi-functional peripheral including a display portion for executing a function of the above-described application and a control server generating control information for displaying an initial screen of each user on the display portion of the multi-functional peripheral to transmit to the multi-functional peripheral, and the above-described control server.

### BACKGROUND OF THE INVENTION

In a conventional multi-functional peripheral, a default screen (copy screen, etc.) to be designated by a setting of the multi-functional peripheral is displayed as an initial screen after login.

Japanese Laid-Open Patent Publication No. 2008-273126 discloses a multi-functional peripheral displaying an initial screen preferred respectively by each user when authentication has been completed successfully with the use of an authentication function provided in the multi-functional peripheral itself to log in. This multi-functional peripheral is configured such that a setting screen of the function that is selected first when a plurality of functions are sequentially selected during login or a setting screen of the function that is frequently selected first is displayed as a preferred initial screen at the next login.

Further, in recent years, a system has been devised in which the function of a multi-functional peripheral and an application which operates on a personal computer (PC) and a server are cooperated with each other, so that the multi-functional peripheral can operate as a part of the total application system. In this system, the multi-functional peripheral is able to provide a user with a beneficial function by cooperating with a control application and service on a network. For example, a function for transmitting scanned data to storage service on the network is included.

Like the multi-functional peripheral disclosed in Japanese Laid-Open Patent Publication No. 2008-273126, in the case where a user displays a setting screen of a function that has been previously selected as an initial screen at the time of login, the following case may occur when it is charged according to the usage of the application cooperated with the function of the multi-functional peripheral. That is, there has been such a problem that a user forgets to be charged and uses a pay application frequently when a setting screen of a function of the pay application that is selected before is displayed as an initial screen immediately after login.

Further, recently, there has been a display screen control system of a multi-functional peripheral that controls an initial screen for each login user displayed by the multi-functional peripheral based on the control information from a control server connected to the multi-functional peripheral, and the above-described problem may occur similarly when the technology disclosed in Japanese Laid-Open Patent Publication No. 2008-273126 is applied to this system.

### SUMMARY OF THE INVENTION

An object of the present invention is to provide a display screen control system and a control server for preventing a user from unconsciously using a pay application in the display screen control system of a multi-functional peripheral composed of a multi-functional peripheral including a display portion for executing a function of an application stored in a application server and a control server that transmits control information for displaying an initial screen based on a usage (selection) history of a function of a user on the display portion of the multi-functional peripheral.

The first technical means of the present invention is a control server that is connected to a multi-functional peripheral having a display portion and capability to execute a function of an application stored in an application server, and when a user logs in the multi-functional peripheral, generates control information for displaying an initial screen on the display portion of the multi-functional peripheral to transmit the generated control information to the multi-functional peripheral, comprising: a usage history information storage portion for storing usage history information of the function of the multi-functional peripheral for each user; a usage fee information storage portion for storing at least usage fee information of the application; and a determination portion for determining whether the function used by the multi-functional peripheral is free of charge or charged, and wherein the control server extracts, based on information of the user who logged in, a predetermined function out of functions used by the user with reference to the usage history information storage portion, performs the determination whether the predetermined function is free of charge or charged at the determination portion with reference to the usage history information storage portion, transmits the control information for displaying a screen of the function to the multi-functional peripheral in the case of free of charge, and transmits the control information for displaying a predetermined alternative screen in stead of the screen of the function to the multi-functional peripheral in the case of being charged.

The second technical means of the present invention is the control server as defined in the first technical means, wherein the predetermined function for extracting is a function that is used last before logout or a function that is used most frequently.

The third technical means of the present invention is the control server as defined in the first technical means, wherein the predetermined alternative screen is a screen of a function of free of charge set in advance, a selected screen of a function of an application or a screen of a free function that is used most frequently.

The forth technical means of the present invention is the control server as defined in the first technical means, wherein the usage fee information storage portion stores information of a term to be charged for the application, the control server performs determination whether the predetermined function is free of charge or charged at the determination portion based on an acquired information of a login time and the information of the term to be charged, and determines as free of charge in the case where the login time is out of the term to be charged.

The fifth technical means of the present invention is the control server as defined in the first technical means, wherein the usage fee information storage portion stores identification information of a predetermined multi-functional peripheral to which the other usage fee different from that of the multi-functional peripheral is applied and information of the different usage fee, the control server performs determination whether the predetermined function is free of charge or charged based on acquired identification information of a multi-functional peripheral of a login source, identification information of the predetermined multi-functional peripheral and information of the different usage fee, and makes a determination result different corresponding to whether the multi-functional peripheral of the login source is the predetermined multi-functional peripheral.

The sixth technical means of the present invention is a display screen control system of a multi-functional peripheral comprising an application server that stores an application, a multi-functional peripheral having a display portion and capability to execute a function of the application and the control server as defined in any one of the first to the fifth technical means, and controlling a display screen on the display portion of the multi-functional peripheral.

### BRIEF DESCRIPTION OF THE DRAWINGS

FIG. 1 is a block diagram illustrating a schematic configuration example of a display control system of a multi-functional peripheral of the present invention;

FIG. 2 is a flowchart for describing an example of initial screen display processing in the system of FIG. 1;

FIG. 3 is a diagram illustrating an example of a login screen displayed in the multi-functional peripheral in the initial screen display processing of FIG. 2;

FIG. 4 is a diagram illustrating an example of a user management table managed by a user information management DB of an authentication server in the system of FIG. 1;

FIG. 5 is a diagram illustrating an example of a last usage function management table managed by the user information management DB of the authentication server in the system of FIG. 1;

FIG. 6 is a diagram illustrating an example of a copy screen displayed in the multi-functional peripheral as an initial screen after login by the initial screen display processing of FIG. 2;

FIG. 7 is a diagram illustrating an example of a scan screen displayed in the multi-functional peripheral as an initial screen after login by the initial screen display processing of FIG. 2;

FIG. 8 is a diagram illustrating an example of a fax screen displayed in the multi-functional peripheral as an initial screen after login by the initial screen display processing of FIG. 2;

FIG. 9 is a diagram illustrating an example of an external application information table managed by an external application information DB of the authentication server in the system of FIG. 1;

FIG. 10 is a diagram illustrating an example of a function of an external application that is not charged displayed in the multi-functional peripheral as an initial screen after login by the initial screen display processing of FIG. 2;

FIG. 11 is a diagram illustrating an example of a selected screen of the function of the external application displayed in the multi-functional peripheral as an initial screen after login by the initial screen display processing of FIG. 2;

FIG. 12 is a diagram illustrating another example of a last usage function management table managed by the user information management DB of the authentication server in the system of FIG. 1;

FIG. 13 is a diagram illustrating another example of the external application information table managed by the external application information DB of the authentication server in the system of FIG. 1; and

FIG. 14 is a diagram illustrating the other example of the external application information table managed by the external application information DB of the authentication server in the system of FIG. 1.

### PREFERRED EMBODIMENTS OF THE INVENTION

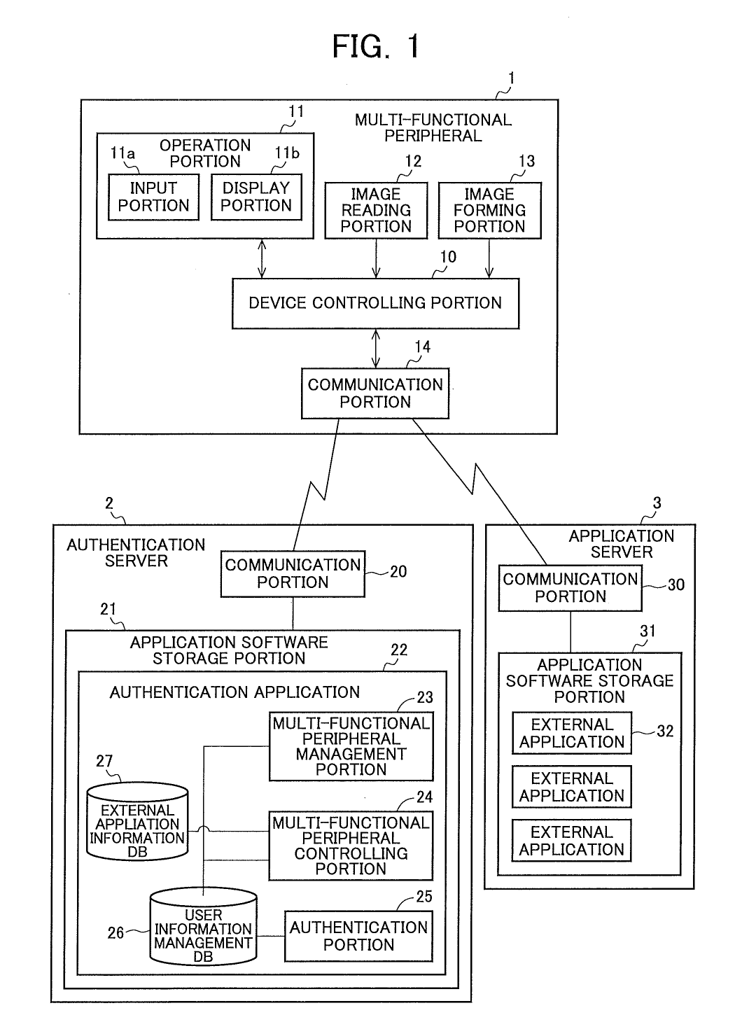

FIG. 1 is a block diagram illustrating a schematic configuration example of a display control system of a multi-functional peripheral of the present invention. The display control system shown in FIG. 1 is provided with a multi-functional peripheral 1, an authentication server 2 and an application server (external application server) 3.

The multi-functional peripheral 1 is a digital multi-functional peripheral or an analogue multi-functional peripheral, and is provided with a device controlling portion 10, an operation portion 11, an image reading portion 12, an image forming portion 13 and a communication portion 14. The device controlling portion 10 controls each portion provided in the multi-functional peripheral 1. The operation portion 11 has an input portion 11a and a display portion 11b such as a liquid crystal display (LCD). The input portion 11a has various input key groups and a touch panel for accepting user input provided in the display portion 11b.

The image reading portion 12 reads a document placed on a document platen or the like and inputs image data. The image forming portion 13 performs printing processing for image data input from the image reading portion 12 or image data input from an external PC via the communication portion 14. The communication portion 14 communicates with the authentication server 2 and the application server 3 via a network such as a wired LAN (Local Area Network).

The authentication server 2 is a server computer provided with a communication portion 20 and an application software storage portion 21, and performs user authentication processing in cooperation with the multi-functional peripheral 1. Additionally, the authentication server 2 functions as a control server that generates display control information for displaying various screens including a login screen and an initial screen on the display portion 11b of the multi-functional peripheral 1 and transmits the generated information to the multi-functional peripheral 1. The communication portion 20 communicates with the multi-functional peripheral 1 via the network such as a wired LAN. The application software storage portion 21 stores an authentication application 22 for controlling the multi-functional peripheral 1.

The authentication application 22 is provided with a multi-functional peripheral management portion 23, a multi-functional peripheral controlling portion 24 and an authentication portion 25 as applications, and is provided with a user information management database (DB) 26 and an external application information DB 27 as data. The multi-functional peripheral management portion 23 relates user information with the multi-functional peripheral 1. The multi-functional peripheral controlling portion 24 generates display control information for screen display in the multi-functional peripheral 1. The authentication portion 25 carries out user authentication. The user information management DB 26 is a database in which user information is managed, and the external application information DB 27 is a database in which external application information is managed.

The device controlling portion 10 of the multi-functional peripheral 1 transmits information of a user operation input by the input portion 11a to the authentication server 2 side via the communication portion 14 and the communication portion 20, and calls a user authentication function of the authentication application 22 and acquires the result of authentication processing thereof by exchanging information for controlling a device of a communication party and device control information serving as information responding thereto between the authentication application 22 stored in the authentication server 2 at the same time.

Moreover, the device controlling portion 10 of the multi-functional peripheral 1 receives display control information from the authentication application 22 via the communication portion 14 and the communication portion 20, and causes the display portion 11b to display an initial screen after login based on this.

The application server 3 is a server computer provided with a communication portion 30 and an application software storage portion 31. The communication portion 30 communicates with the multi-functional peripheral 1 via the network such as a wired LAN or a wireless LAN. The application software storage portion 31 stores an external application 32 for controlling the multi-functional peripheral 1.

The device controlling portion 10 of the multi-functional peripheral 1 transmits the information of an user operation input by the input portion 11a to the application server 3 side via the communication portion 14 and the communication portion 30, and calls the function of the external application 32 and acquires the result of processing thereof by exchanging the device control information between the external application 32 stored in the application server 3 at the same time. This allows the multi-functional peripheral 1 to perform processing in cooperation with the external application 32.

Next, description will be given to initial screen (initial screen after login) display processing, which is a main characteristic of the present invention.

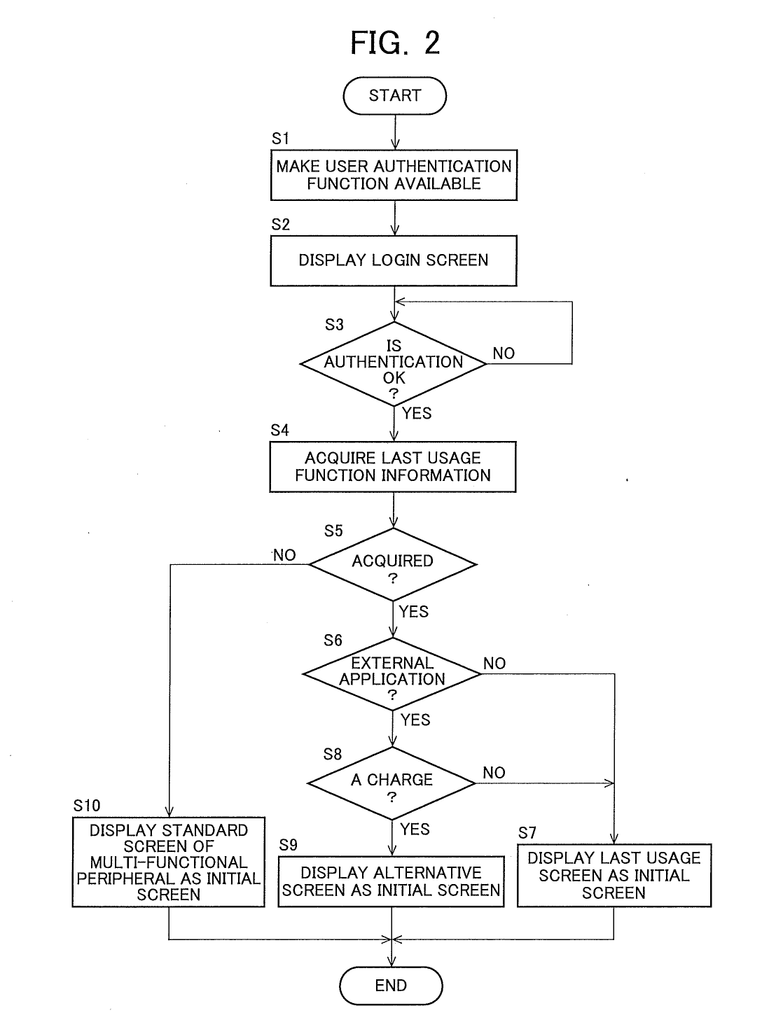

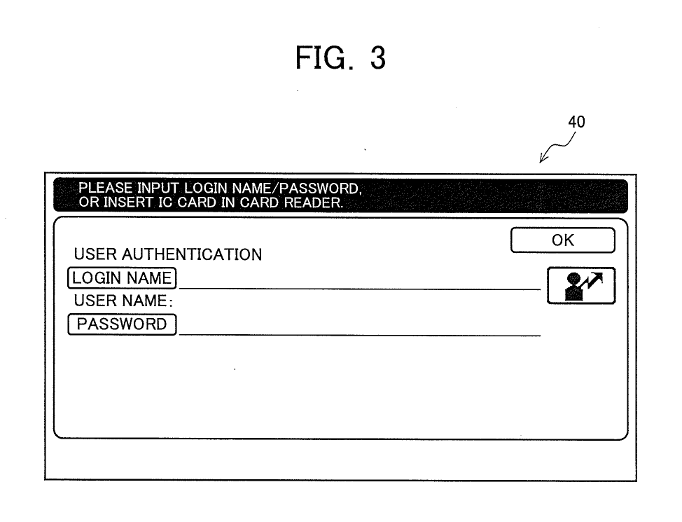

FIG. 2 is a flowchart for describing an example of initial screen display processing in the system of FIG. 1. Further, FIG. 3 is a diagram illustrating an example of a login screen displayed in the multi-functional peripheral by the initial screen display processing of FIG. 2.

User authentication processing performed by the multi-functional peripheral 1 and the authentication server 2 in cooperation with each other begins from activating an authentication function first (step S1). At the step S1, when an administrator of the multi-functional peripheral performs an operation of activating the user authentication function from the operation portion 11, information indicating that the administrator performs the operation is transmitted to the device controlling portion 10 and the user authentication function is availably set.

When the user authentication function becomes available, the device controlling portion 10 of the multi-functional peripheral 1 causes the display portion 11b to display an authentication screen (login screen) (step S2). Thereby, for example, a login screen 40 of FIG. 3 is displayed. The login screen 40 allows inputting of a login name and a password.

A user inputs login information consisting of a user name and a password by the input portion 11a, and the device controlling portion 10 that has received it requests user authentication processing to the authentication server 2 and the authentication application 22 of the authentication server 2 that has received the request determines whether or not the authentication has been completed successfully (step S3).

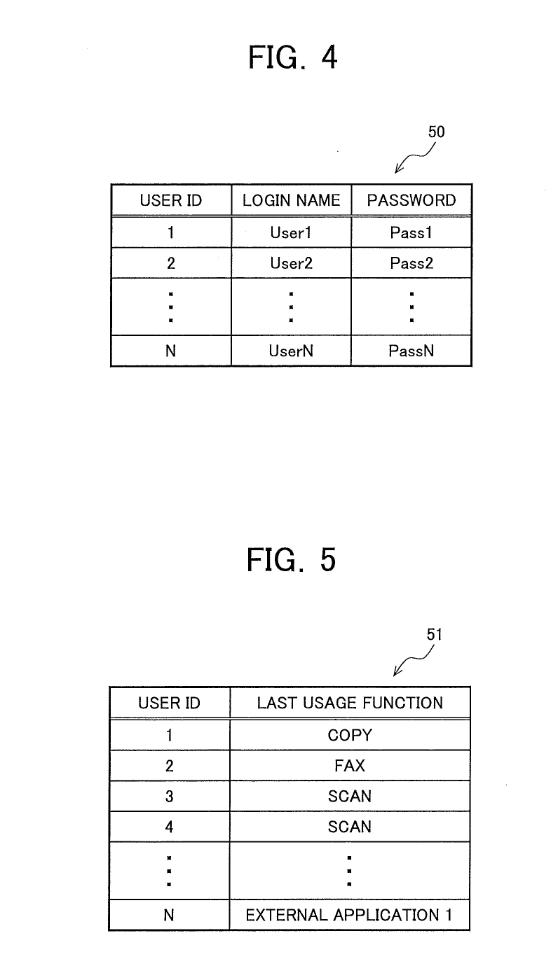

The user authentication processing at the step S3 is performed, for example, based on the user management table 50 of FIG. 4. The user management table 50 is included in the user information management DB 26, in which a login name and a password are stored for each user ID as each user authentication information.

The login information input by the user is transmitted from the multi-functional peripheral 1 to the authentication server 2. Then, the authentication portion 25 checks the received login information with the user management table 50 and carries out the authentication based on whether or not there is user authentication information that agrees with the received login information in the user management table 50.

Description will be returned to FIG. 2.

When the authentication fails (in the case of NO at the step S3), a response is sent to the multi-functional peripheral 1 side as an authentication error, and the device controlling portion 10 of the multi-functional peripheral 1 causes the display portion 11b to display the login screen again to urge the user to re-entry of the login information. When the authentication is succeeded (in the case of YES at the step S3), the multi-functional peripheral controlling portion 24 acquires (extracts) information of a function that satisfies predetermined conditions from the user information management DB 26, in this example, last usage function information described below (step S4) in order to display an initial screen after login.

Description will be given for an example of control for displaying an initial screen after login on the display portion 11b with reference to FIG. 5 to FIG. 10.

FIG. 5 is a diagram illustrating an example of a last usage function management table managed by the user information management DB of the authentication server in the system of FIG. 1. In the last usage function management table 51 of FIG. 5, information of a last usage function is stored for each user ID. The above-described last usage function information is the information indicating a function which the user used last (most recently used) in previous login, and is acquired by updating for each time of use. In the example, it is indicated that functions which a user of user ID “1” and a user of user ID “N” used last are a copy function and a function of the external application 1, respectively.

At the step S4, the multi-functional peripheral controlling portion 24 acquires last usage function information of a user from the last usage function management table 51 of the user information management DB 26 using the login information of the user which the authentication is succeeded at the step S3 as a key.

The multi-functional peripheral controlling portion 24 determines whether or not the last usage function information of the user is acquired (step S5). When acquired (in the case of YES), the multi-functional peripheral controlling portion 24 determines whether a function indicated by the last usage function information is a function of the external application stored in the application server 3 (step S6).

The multi-functional peripheral controlling portion 24, for example, in the case where the last usage function information is “copy”, “fax”, “scan” or the like and the function indicated by the information is not a function of the external application (in the case of NO at the step S6), transmits display control information (control command) to the multi-functional peripheral 1 so as to display a screen of a function indicated by the last usage function information (referred to as a last usage screen), and the device controlling portion 10 causes the display portion 11b to display the last usage screen as an initial screen after login according to display control information thereof (step S7). As the screen of the function indicated by the last usage function information, an initial screen of the function may be employed.

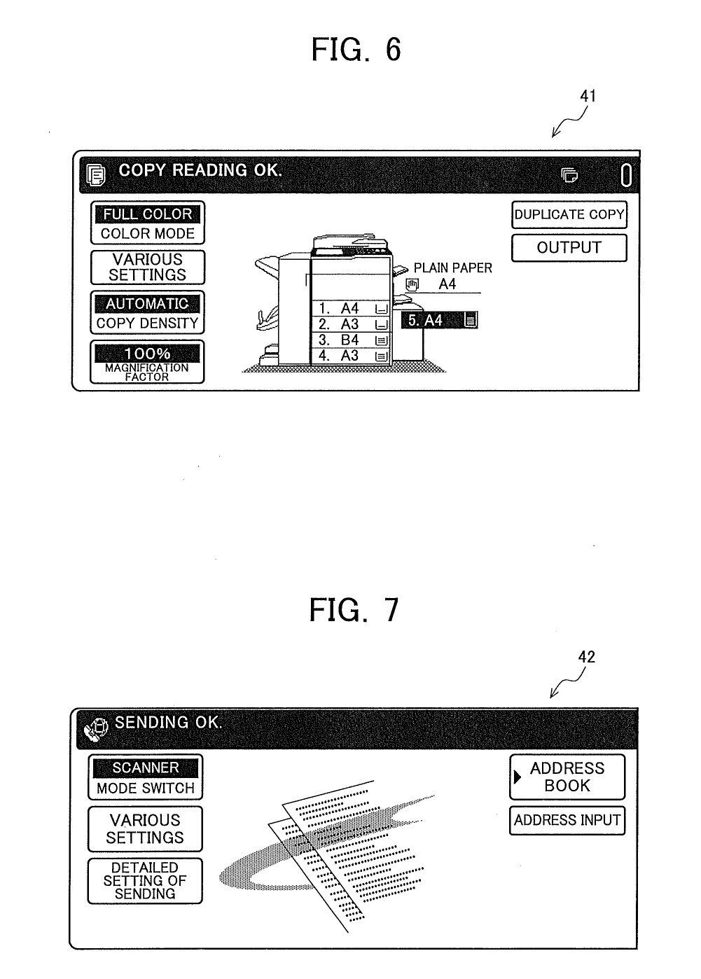

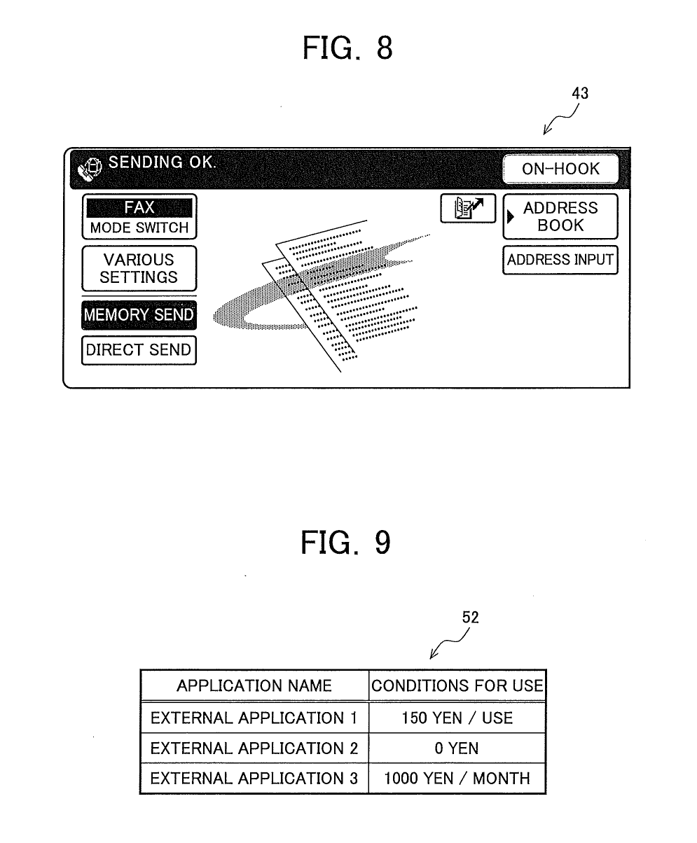

FIGS. 6, 7, and 8 are diagrams illustrating an example of a copy screen, a scan screen, and a fax screen, respectively, displayed in the multi-functional peripheral as an initial screen after login by the above-described initial screen display processing. A copy screen 41 of FIG. 6, a scan screen 42 of FIG. 7 and a fax screen 43 of FIG. 8 are all initial screens of the function of the multi-functional peripheral itself, each of which is displayed when a user ID is “1” and “3” or “4” and “2” in an example of the last usage function management table 51.

On the other hand, at the step S6, in the case where the function indicated by the last usage function information is the function of the external application (in the case of YES), determination is made whether or not the external application is charged (step S8).

Processing for determining whether or not it is a charge at the step S8 is performed, for example, based on the external application information table of FIG. 9. An external application information table 52 of FIG. 9 is included in the external application information DB 27 and stores usage fee information for each external application. An example of FIG. 9 shows that the function of the external application 1 is charged 150 yen for each use, a function of an external application 2 is usable free of charge and the function of the external application 3 is, although requiring a monthly fee, usable anytime in the month for which the payment is performed.

The multi-functional peripheral controlling portion 24, for example, in the case where the last usage function information is an “external application 1”, determines that the external application is charged. Note that, concerning an application that needs a fee but is usable anytime during a given period of time once paid like the function of the external application 3, it may be determined as being charged or determined as being not charged.

At the step S8, in the case where the external application is not charged (in the case of NO), the multi-functional peripheral controlling portion 24 proceeds the processing to the step S7, transmits display control information to the multi-functional peripheral 1 so as to display the screen of the function of the external application and causes the multi-functional peripheral 1 to perform a display based on the display control information.

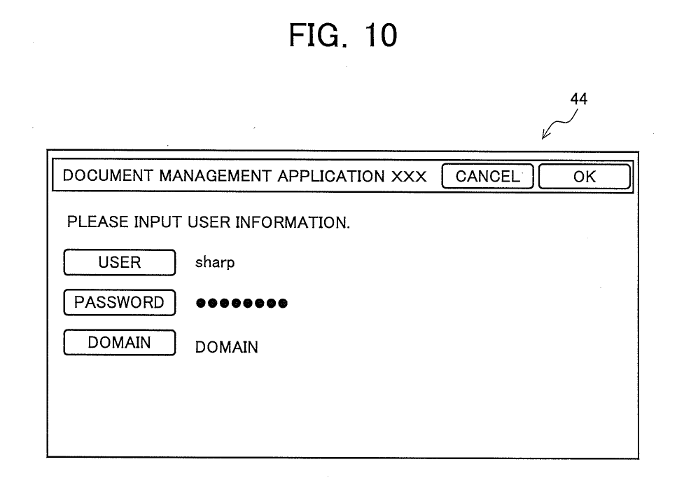

FIG. 10 is a diagram illustrating an example of a screen of the function of the external application which is not charged to be displayed in a multi-functional peripheral as an initial screen after login by the above-described initial screen display processing. A screen 44 of FIG. 10 is a screen of a function of the external application “document management application XXX” out of external applications 32 stored in the application server 3.

On the other hand, at the step S8, in the case where the external application is charged (in the case of YES), the multi-functional peripheral controlling portion 24 generates display control information so as to display a screen different from the screen of the function of the external application (alternative screen described below) to transmit to the multi-functional peripheral 1, and the device controlling portion 10 causes the display portion 11b to display the above-described alternative screen as an initial screen after login according to the display control information (step S9).

The alternative screen is accepted in the case of not being a screen of the function of a pay external application, and for example, is a screen that has been set in advance as a screen often used in general such as an initial screen of a copy function.

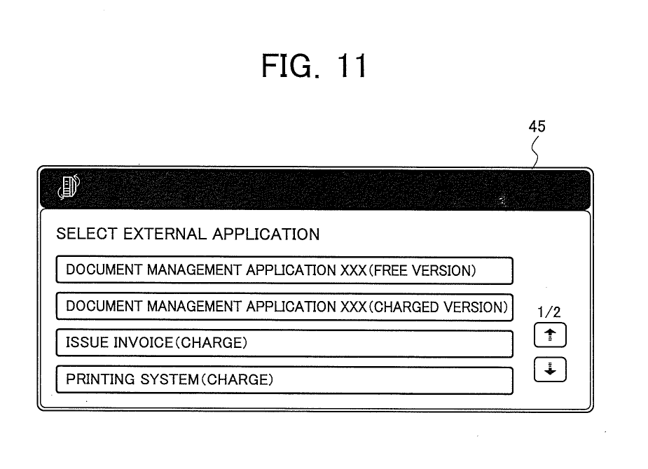

Further, the alternative screen may be a selected screen 45 of the function of the external application as shown in FIG. 11. In the selected screen 45, a title of an application and information on whether or not the application is charged are indicated together, and it is possible to prevent a user from unconsciously selecting and using a pay external application.

Note that, at the step S5, when the last usage function information of the user can not be acquired, the multi-functional peripheral controlling portion 24 transmits display control information to the multi-functional peripheral 1 so as to display a standard screen (standard initial screen) of the multi-functional peripheral 1, and the device controlling portion 10 causes the display portion 11b to display the standard screen as an initial screen after login according to display control information thereof (step S10).

Moreover, in the above, for the function that meets the condition that it is used last, corresponding to whether or not the function is a function of a pay external application, a screen of the function is used as an initial screen immediately after login or the alternative screen is used as an initial screen, however, for the function that meets the condition that is used most frequently, similarly, the screen of the function may be used as an initial screen immediately after login or the alternative screen may be used as an initial screen. In such a case, in stead of the last usage function management table 51 of FIG. 5, for example, a function use frequency table storing the number of use of each function for each user ID is included in the user information management DB 26 and the information of a function that is most frequently used may be acquired in stead of the last usage function information.

In this way, in the present invention, a function corresponding to the conditions related to a usage history (the condition of last usage or the condition of the most frequent use) of a multi-functional peripheral is extracted to determine whether the function is free of charge or a charge, and more specifically, determine whether or not the function is a function of the pay external application. Then, in the case where the function is not the function of the pay external application and is free of charge, the screen of the function is displayed as an initial screen after login, and in the case where the function is the function of the pay external application and is charged, the alternative screen of the screen of the function (screen of a function of free of charge such as a copy function and an external application selection screen) is displayed as the above-described initial screen. Therefore, it is possible to secure convenience of a user while prevent a user from unconsciously using a pay application via the multi-functional peripheral.

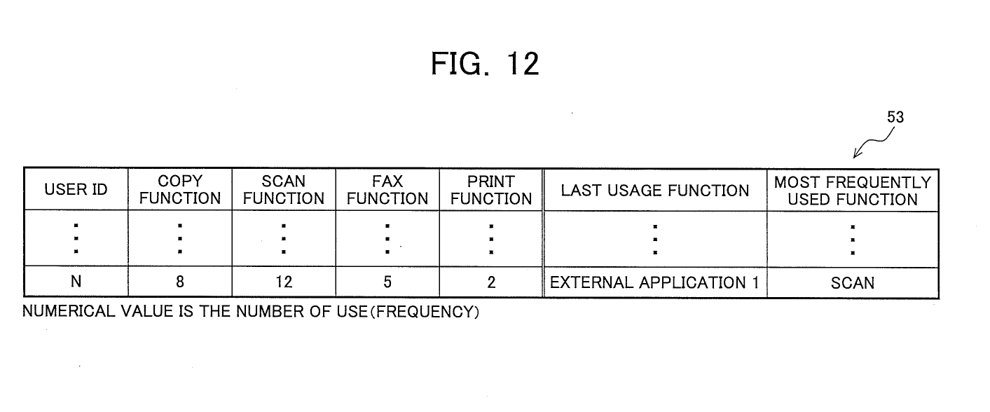

In the above-described example, the screen that has been set as an alternative screen in advance is used, however, a screen of a function that is used most frequently by a user and not charged may be used as the alternative screen. FIG. 12 is a diagram illustrating an example of the last usage function management table managed by the user information management DB of the authentication server in the system of FIG. 1 in the case where the screen of the function that is used most frequently by the user and not charged is used as the alternative screen.

In a last usage function management table 53 of FIG. 12, the number of use for each function other than the function of the external application is stored for each user ID and also the information of the last usage function and the most frequently used function is stored for each user ID. Based on this, the multi-functional peripheral controlling portion 24 is able to determine the last usage function and the most frequently used function of a user and designate an initial screen in login. Note that, although differing from the example shown in FIG. 12, concerning a function of the application of free of charge, the number of use is stored (recorded) so that the screen of the function of the application of free of charge may also be able to be designated as an alternative screen.

The above-described last usage function information and most frequently used function information are acquired by updating the information of the function used by the user appropriately. Specifically, for example, when the copy screen 41 of FIG. 6 is selected in the multi-functional peripheral 1 or a button or the like for instructing to execute a copy is pressed, the information of the corresponding function (copy function in this case) is transmitted from the multi-functional peripheral 1, and therefore, the multi-functional peripheral controlling portion 24 receives the information and performs the processing as described below. That is, the multi-functional peripheral controlling portion 24 acquires the last usage function information out of the received information of the above-described function and performs an update by replacing it with the last usage function information corresponding to user ID that is currently being logged in in the last usage function management table 51 of the user information management DB 26. Additionally, in the case of using the last usage function table 54, corresponding to the above-described reception, the last usage function information is updated similarly as described above and the number of use of the corresponding function that is currently logged in is increased by one, and also, thereby the most frequently used function is updated in the case of being changed.

In the above-described example, the determination is performed whether or not the function corresponding to the predetermined conditions related to the usage history of the multi-functional peripheral is a function of the pay external application with the use of the external application information table 52 of FIG. 9 based on only the information of the usage fee of the external application, however, the above-described determination may be performed as follows with the use of external application information tables 54 and 55.

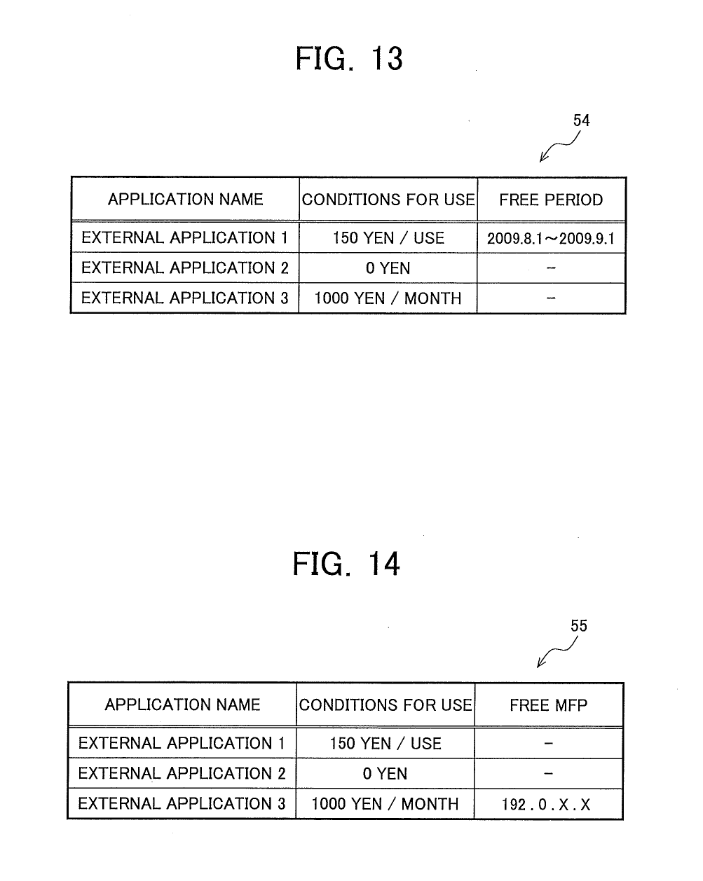

The external application information table 54 of FIG. 13 is included in the external application information DB 27 and stores the usage fee information and the information of a term to be charged for each external application, and an example of FIG. 13 shows that the function of the external application 1 that is usually charged is not charged from Aug. 1, 2009 to Sep. 1, 2009.

In the case of using this table 54, the multi-functional peripheral controlling portion 24 acquires a login time at the step S3 or the step S4. Then, with reference to the external application information table 54, for example, in the case where the login time is out of the term to be charged (when the login time (the date of login) is Aug. 3, 2009 or the like) even when the last usage function information is the “external application 1”, which is usually the pay external application, at the step S8, the determination is made that the external application is free of charge. Subsequently, a last usage screen is displayed as an initial screen after login.

Such a configuration makes it possible to perform appropriate display control in the case where the pay external application has the conditions of the term to be charged such as a free trial period.

Note that, the login time may be acquired from the multi-functional peripheral 1, or the time when the authentication server 2 was accessed for login, that is counted in a calendar within the server 2, is acquired to be used as the login time.

The external application information table 55 of FIG. 14 is included in the external application information DB 27, and stores the usage condition different from the information of the specified multi-functional peripheral to which the usage fee different from that of another multi-functional peripheral is applied (information that is able to specify the multi-functional peripheral such as an IP address, a product serial number and an MAC address) and the different usage conditions as well as the information of the usage fee for each external application. An example of FIG. 14 shows that the function of the external application 3 that is usually charged is not charged for the multi-functional peripheral whose IP address is 192.0.X.X.

In the case of using this table 55, the multi-functional peripheral controlling portion 24, for example, at the step S3 or the step S4, acquires the IP address of the MFP of a login source. Then, with reference to the external application information table 55, for example, even when the last usage function information is the “external application 3”, which is the external application that is usually charged, at the step S8, the determination is made that the external application is free of charge in the case where the IP address of the multi-functional peripheral of the login source is 192.0.X.X. Thereafter, the last usage screen is displayed as the initial screen after login.

Such a configuration makes it possible to realize a free setting according to the situation, such as increasing the number of users by making a specified MFP free of charge.

Note that, an authentication screen (login screen) to be displayed by the multi-functional peripheral 1 and a screen of each function displayed as an initial screen can be displayed by reading from an internal memory of the multi-functional peripheral 1. However, a screen of a function of the external application can be acquired from an internal memory of the application server 3 to be displayed, and a screen of the other function can be acquired from an internal memory of the authentication server 2 to be displayed.

Further, in the system, it is preferred that the exchanging of information between the multi-functional peripheral 1 and the external application 32 is performed on the basis of a standard network technology on the point that many general tools and skills can be used to develop a part of cooperation between the external application 32 and the device controlling portion 10 (firmware in the device controlling portion 10) of the multi-functional peripheral 1 and mounting thereof is easy. Note that, the same thing can be said for the exchanging of information between the authentication application 22 and the multi-functional peripheral 1 described above.

According to the present invention, an initial screen is displayed on the display portion of a multi-functional peripheral based on a usage history of a user to secure convenience of the user, and it is possible to prevent the user from unconsciously using a pay application via the multi-functional peripheral.

1. A control server that is connected to a multi-functional peripheral having a display portion and capability to execute a function of an application stored in an application server, and when a user logs in the multi-functional peripheral, generates control information for displaying an initial screen on the display portion of the multi-functional peripheral to transmit the generated control information to the multi-functional peripheral, comprising:
a usage history information storage portion for storing usage history information of the function of the multi-functional peripheral for each user;
a usage fee information storage portion for storing at least usage fee information of the application; and
a determination portion for determining whether the function used by the multi-functional peripheral is free of charge or charged, and wherein
the control server extracts, based on information of the user who logged in, a predetermined function out of functions used by the user with reference to the usage history information storage portion,
performs the determination whether the predetermined function is free of charge or charged at the determination portion with reference to the usage history information storage portion,
transmits the control information for displaying a screen of the function to the multi-functional peripheral in the case of free of charge, and
transmits the control information for displaying a predetermined alternative screen in stead of the screen of the function to the multi-functional peripheral in the case of being charged.

2. The control server as defined in claim 1, wherein
the predetermined function for extracting is a function that is used last before logout or a function that is used most frequently.

3. The control server as defined in claim 1, wherein
the predetermined alternative screen is a screen of a function of free of charge set in advance, a selected screen of a function of an application or a screen of a free function that is used most frequently.

4. The control server as defined in claim 1, wherein
the usage fee information storage portion stores information of a term to be charged for the application,
the control server performs determination whether the predetermined function is free of charge or charged at the determination portion based on an acquired information of a login time and the information of the term to be charged, and determines as free of charge in the case where the login time is out of the term to be charged.

5. The control server as defined in claim 1, wherein
the usage fee information storage portion stores identification information of a predetermined multi-functional peripheral to which the other usage fee different from that of the multi-functional peripheral is applied and information of the different usage fee,
the control server performs determination whether the predetermined function is free of charge or charged based on acquired identification information of a multi-functional peripheral of a login source, identification information of the predetermined multi-functional peripheral and information of the different usage fee, and makes a determination result different corresponding to whether the multi-functional peripheral of the login source is the predetermined multi-functional peripheral.

6. A display screen control system of a multi-functional peripheral comprising an application server that stores an application, a multi-functional peripheral having a display portion and capability to execute a function of the application and the control server as defined in any one of claims 1 to 5, and controlling a display screen on the display portion of the multi-functional peripheral.
